(19) United States
(12) Patent Application Publication
(10) Pub. No.: US 2022/0164429 A1
(43) Pub. Date: May 26, 2022

(54) TOUCHLESS AUTHENTICATION AT RESOURCE DISTRIBUTION SYSTEMS

(71) Applicant: BANK OF AMERICA CORPORATION, Charlotte, NC (US)

(72) Inventors: Cody Dean Searl, Pineville, NC (US); Lisa Matthews, Charlotte, NC (US)

(73) Assignee: BANK OF AMERICA CORPORATION, Charlotte, NC (US)

(21) Appl. No.: 17/104,878

(22) Filed: Nov. 25, 2020

(51) Int. Cl. G06F 21/35; G06Q 20/40; G06Q 20/32; G06Q 20/10; H04W 4/80

(52) U.S. Cl. CPC G06F 21/35; G06Q 20/4014; H04W 4/80; G06Q 20/1085; G06Q 20/3278

(57) ABSTRACT

Touchless/contactless user authentication is provided at apparatus requiring user authentication. The user authentication credentials are input or otherwise communicated to the apparatus absent the need to physically contact the input mechanisms of the apparatus or the display of the user communication device. The user communication device is equipped with motion sensing mechanisms configured to detect a preconfigured user gesture, which is either preconfigured to be associated with specific user authentication credentials or serves as the user authentication credentials. Monitoring for the preconfigured user gesture is initiated by a triggering event, which may include co-location of the user communication device and the apparatus or short-range wireless communication between the user communication device and the apparatus.

### FIELD OF THE INVENTION

The present invention relates to user authentication and, more specifically, for providing touchless or contactless authentication at apparatus requiring such, e.g., resource distribution systems, resource transaction systems and stand-alone authentication systems and the like.

### BACKGROUND

The problem with most apparatus that require user authentication (e.g., Automated Teller Machines (ATM), point-of-sale (POS) devices or stand-alone authentication devices or the like) is that the apparatus requires a user to physically interface with apparatus in order to input their user authentication credentials (e.g., personal identification number (PIN), password, zip code or the like). Since these types of apparatus incur continuous use by different individuals, the likelihood of individuals acquiring germs from physically touching the input mechanisms is high. In the case of providing such inputs to an apparatus' touchscreen, this problem is seemingly unavoidable, since a touchscreen sensor requires that inputs be provided by a finger or a specialized stylus.

Heretofore, attempts to address the problem related to users having to physically contact such user authentication-requiring apparatus have been ineffective or inefficient. In this regard, some of the proposed solutions still require the user to at least make minimal contact with the apparatus. In other instances, the proposed solutions are so cumbersome to the user that the user would rather forego using the solution and instead run the perils associated with contacting the apparatus. In other instances, in which the user is able to input their authentication credentials on their user communication device (e.g., smart phone or the like), the authentication process is not contactless, since the user is still making contact with a device, which may be no more sanitary than the apparatus requiring the user authentication credentials.

Therefore, a need exists to develop systems, methods, computer program products and the like that provide contactless user authentication. The desired systems, methods, computer program products and the like should allow a user to input/communicate their user authentication credentials without having to physically contact either the apparatus requiring the user authentication credentials or their user communication device. In addition, the desired systems, methods and computer program products should provide for an efficient and easily implemented means for providing their user authentication credentials without physically contacting the apparatus. In this regard, the desired, systems, methods, computer program products and the like should allow the user to communicate/input their user authentication credentials in the same timeframe that a user would otherwise input their user authentication credentials through direct contact with the apparatus. Further, the process by which the user contactlessly provides user authentication credentials should be highly intuitive so that the user is not required to recall what needs to take place in order for the contactless process to ensue.

### SUMMARY OF THE INVENTION

The following presents a simplified summary of one or more embodiments in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing contactless user authentication at apparatus requiring a user to provide user authentication credentials. As previously discussed, such apparatus typically require the user to physically contact the apparatus (e.g., keypad or touchscreen inputs) to input their user authentication credentials (e.g., password, PIN, zip code or the like). Contacting such apparatus may be undesirable due to the likelihood of the user acquiring germs from such publicly-used input mechanisms.

Specifically, the invention relies on the user communication device being equipped with motion sensing devices (e.g., accelerometers or the like) that are capable to detecting user gestures, which are either associated with the user authentication credentials or otherwise serve as the user authentication credentials. The user communication device may be a mobile communication device, such as a smart phone or a wearable device, such as smart watch/bracelet, smart glasses or the like.

In specific embodiments of the invention, the occurrence of a predetermined triggering event results in monitoring for the occurrence of the user gesture. The triggering event may be co-location of the user communication device and the apparatus (i.e., the user communication device is within a predetermined distance of the apparatus) or the triggering event may be short-range wireless communication between the user communication device and the apparatus (e.g., “tapping” a near filed wireless communication equipped-user communication device to a corresponding reader on the apparatus). Once the user gesture is detected, the user credentials are wirelessly communicated to the apparatus (e.g., communicated to a backend system included as part of the apparatus), which verifies the user authentication credentials for providing the user with access to or approval for subsequent interactions, which may be performed on the apparatus itself.

Thus, the present invention allows the user to input/communicate their authentication credentials to apparatus requiring such without having to contact the input mechanism on the apparatus or the display on their respective user communication device.

A system for contactless user authentication defines first embodiments of the invention. The system includes an apparatus having a first memory and at least one processor in communication with the memory. The apparatus is configured to require a user to provide user authentication credentials to authorize the user for conducting one or more subsequent interactions. The system additionally includes a user communication device including a second memory, at least one second processor in communication with the second memory and a motion sensing device in communication with the at least one second processor. Additionally, the system includes a contactless authentication application that is stored in the second memory and executable by the second processor. The contactless authentication application is configured to identify a triggering event associated with the user communication device and the apparatus. In response to identifying an occurrence of the triggering event, the contactless authentication application is further configured to initiate monitoring of the user communication device for a predefined user gesture. In response to the motion sensing device detecting an occurrence of the predefined user gesture, the contactless authentication application is configured to wirelessly communicate the user authentication credentials to the apparatus, and, in response to verifying the user authentication credentials, provide the user authorization for conducting the one or more subsequent interactions.

In specific embodiments of the system, the user communication device further includes a location determining mechanism in communication the at least one second processor. In such embodiments of the system, the triggering event is defined as determination of co-location between the user communication device and the apparatus.

In other specific embodiments of the system, the user communication device further includes a short-range wireless communication mechanism in communication with the at least one second processor. In such embodiments of the system, the triggering event is defined as detection of short-range wireless communication between the user communication device and the apparatus.

In further specific embodiments of the system, the user communication device is a mobile communication device or a wearable device including a display in communication with the at least one second processor. In related embodiments of the system, the contactless authentication application or some other application is configured to, in response to verifying the user authentication credentials, provide one or more user interfaces on the display that are configured to allow the user to provide inputs to the user interfaces to conduct one or more subsequent interactions with the apparatus without physically contacting the apparatus.

In additional specific embodiments of the system, the apparatus is selected from the group consisting of (i) an automated teller machine, (ii) a point of transaction device, and (iii) an identification verification device.

In still further specific embodiments of the system, the contactless authentication application is further configured to wirelessly communicate the user authentication credentials to the apparatus by communicating, via a wireless network connection, the user authentication credentials to a backend system configured to verify the user authentication credentials. In such embodiments of the invention, the backend system is part of the apparatus and is configured to, in response to verifying the user authentication credentials, communicate, via a network connection, the user authorization to the local apparatus.

Moreover, in further embodiments of the system, the contactless authentication application is further configured to, in response to identifying the occurrence of the triggering event, determine the user authentication credentials required by the apparatus (e.g., the password, personal identification number (PIN) or the like associated with the gesture). In other embodiments of the system. The user authentication credential is the predetermined gesture (i.e., no need to associate the gesture with a password, PIN or the like.

A computer-implemented method for contactless user authentication defines second embodiments of the invention. The method is executed by at least one computing device processor. The method includes identifying an occurrence of a triggering event associated with a user communication device configured to detect motion and an apparatus configured to require a user to provide user authentication. The method further includes, in response to identifying the occurrence of the triggering event, initiating monitoring of the user communication device for a predefined user gesture. Further, the method includes, in response to the detecting the predefined user gesture, wirelessly communicating the user authentication credentials to the apparatus. Additionally, the method includes, in response to verifying the user authentication credentials, providing the user authorization for conducting the one or more subsequent interactions.

In specific embodiments of the computer-implemented method, identifying the occurrence of a triggering event further includes determining co-location between the user communication device and the apparatus.

In other specific embodiments of the method, identifying the occurrence of a triggering event further includes detecting short-range wireless communication between the user communication device and the apparatus.

In still further specific embodiments the computer-implemented method includes, in response to verifying the user authentication credentials, providing one or more user interfaces on a display of the user communication device that are configured to allow the user to provide inputs to the user interfaces to conduct one or more subsequent interactions with the apparatus without physically contacting the apparatus.

In additional specific embodiments of the computer-implemented method, wirelessly communicating the user authentication credentials to the apparatus further comprises communicating, via a wireless network connection, the user authentication credentials to a backend system configured to verify the user authentication credentials. In response to the backend system verifying the user authentication credentials, communicating, via a network connection, the user authorization to the apparatus.

In further specific embodiments the computer-implemented method includes in response to identifying the occurrence of the triggering event, determining the user authentication credentials required by the apparatus. In other embodiments of the method, the gesture itself is the user authentication credentials.

A computer program product including a non-transitory computer-readable medium defines third embodiments of the invention. The computer-readable medium includes a first set of codes for causing a computer to identify an occurrence of a triggering event associated with a user communication device configured to detect motion and an apparatus configured to require a user to provide user authentication. The computer-readable medium additionally includes a second set of codes for causing a computer to, in response to identifying the occurrence of the triggering event, initiate monitoring of the user communication device for a predefined user gesture. Further, the computer-readable medium includes a third set of codes for causing a computer to, in response to the detecting the predefined user gesture, wirelessly communicate the user authentication credentials to the apparatus. Moreover, the computer-readable medium includes a fourth set of codes for causing a computer to, in response to verifying the user authentication credentials, provide the user authorization for conducting the one or more subsequent interactions.

In specific embodiments of the computer program product, the first set of codes is further configured to identify the occurrence of a triggering event by determining co-location between the user communication device and the apparatus.

In other specific embodiments of the computer program product, the first set of codes is further configured to identify the occurrence of a triggering event by detecting short-range wireless communication between the user communication device and the apparatus.

In still further embodiments of the computer program product, the computer-readable medium includes a fifth set of codes for causing a computer to, in response to verifying the user authentication credentials, providing one or more user interfaces on a display of the user communication device that are configured to allow the user to provide inputs to the user interfaces to conduct one or more subsequent interactions with the apparatus without physically contacting the apparatus.

Thus, systems, apparatus, methods, and computer program products herein described in detail below provide for a user to contactlessly provide their user authentication credentials to an apparatus requiring such. In this regard, the user authentication credentials are input or otherwise communicated to the apparatus absent the need to physically contact the input mechanisms of the apparatus or the display of the user communication device. The invention relies on the user communication device to detect preconfigured user gestures, which are either associated with specific user authentication credentials or serve as the user authentication credential. Monitoring for the preconfigured user gesture is initiated by a triggering event, which may include co-location of the user communication device and the apparatus or short-range wireless communication between the user communication device and the apparatus.

### BRIEF DESCRIPTION OF THE DRAWINGS

Having thus described embodiments of the invention in general terms, reference will now be made the accompanying drawings, wherein:

FIG. 1 is a schematic/block diagram of a system for touchless/contactless user authentication, in accordance with embodiments of the present invention;

FIG. 2 is a schematic/block diagram of a system for touchless/contactless user authentication highlighting the different types of user communication devices and apparatus, in accordance with embodiments of the present invention;

FIG. 3 is a block diagram of a user communication device configured for touchless/contactless user authentication, in accordance with embodiments of the present invention; and

FIG. 4 is a flow diagram of a method for touchless/contactless user authentication, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as PYTHON, JAVA, PERL, SMALLTALK, C++, SPARK SQL, HADOOP HIVE or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” or “configured for” perform (or “configured for” performing) a certain function in a variety of ways, including, for example, by having one or more general-purpose circuits perform the function by executing particular computer-executable program code embodied in computer-readable medium, and/or by having one or more application-specific circuits perform the function.

Thus, as described in more detail below, embodiments of the present invention provide for touchless/contactless user authentication at apparatus requiring a user to provide user authentication credentials. As previously discussed, such apparatus typically require the user to physically contact the apparatus (e.g., keypad or touchscreen) to input their user authentication credentials (e.g., password, PIN, zip code or the like). Contacting such apparatus may be undesirable due to the likelihood of the user acquiring germs from such publicly-used input mechanisms.

Specifically, the invention relies on the user communication device being equipped with motion sensing devices (e.g., accelerometers or the like) that are capable to detecting user gestures, which are either associated with the user authentication credentials or otherwise serve as the user authentication credentials. The user communication device may be a mobile communication device, such as a smart phone or a wearable device, such as smart watch/bracelet, smart glasses or the like.

In specific embodiments of the invention, the occurrence of a predetermined triggering event results in monitoring for the occurrence of the user gesture. The triggering event may be co-location of the user communication device and the apparatus (i.e., the user communication device is within a predetermined distance of the apparatus) or the triggering event may be short-range wireless communication between the user communication device and the apparatus (e.g., “tapping” a near filed wireless communication equipped-user communication device to a corresponding reader on the apparatus). Once the user gesture is detected, the user credentials are wirelessly communicated to the apparatus (e.g., communicated to a backend system included as part of the apparatus), which verifies the user authentication credentials for providing the user with access to or approval for subsequent interactions, which may be performed on the apparatus itself.

In further embodiments of the invention, once the authentication credentials have been verified, a display on the user communication device may present user interfaces that are configured to receive user inputs to conduct the subsequent interactions on the user communication device as opposed to on the apparatus. In this regard, not only is user authentication performed without the user having to contact the apparatus, but also the authorized interactions may be performed without the user having to contact (i.e., provide inputs to) the apparatus.

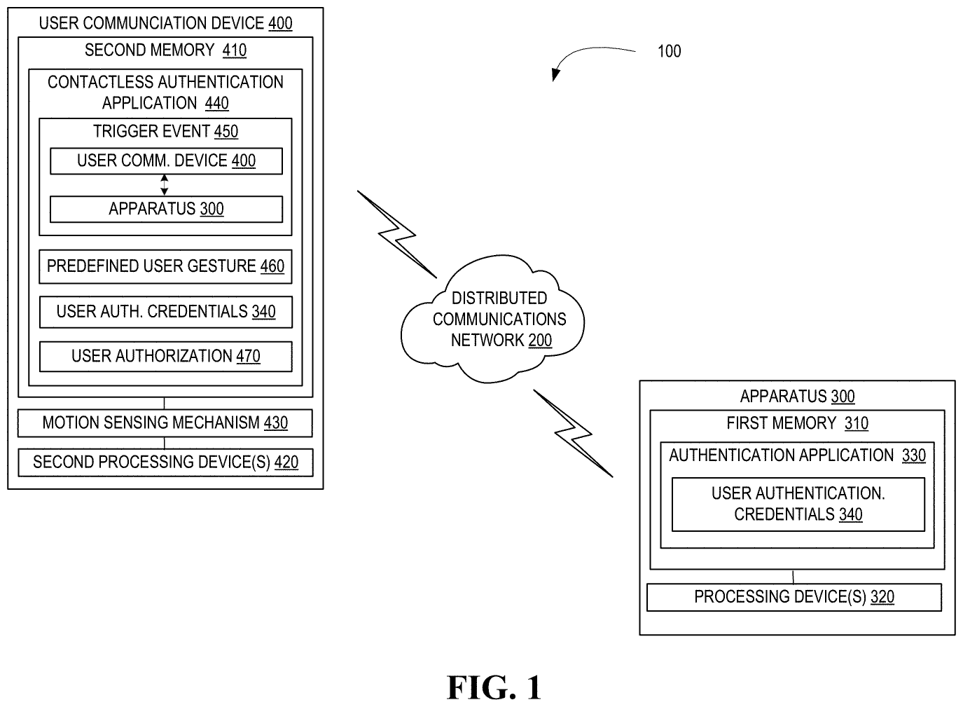

Turning now to the figures, FIG. 1 illustrates a system 100 for touchless/contactless use authentication, in accordance with embodiments of the invention. The system 100 is implemented in a distributed communication network 200, which may include the Internet, one or more intranets, one or more cellular networks or the like. The system 100 includes an apparatus 300 and a user communication device 400. The apparatus 300 includes first memory 310 and one or more first processing devices 320 in communication with first memory 310. First memory 310 stores an authentication application 330 that is configured to receive user authentication credentials 340 for purposes of verifying the identity of the user and authorizing the user to conduct subsequent interactions. Typically, the apparatus 400 includes input mechanisms (e.g., keypads, touchscreens or the like) that are configured to receive user inputs that define the user authentication credentials 340. However, the present invention allows for the user to input their user authentication credentials 340 without having to physically contact apparatus 300. Further, apparatus 300 may include more than one device. For example, apparatus 300 may a user interface device, as well as, one or more backend devices, servers or the like (referred to herein as a “backend system”) that are in network communication with the user interface device physically.

User communication device 400 includes a second memory 410 and one or more second processors 420 in communication with second memory 410. Additionally, user communication device 400 includes motion sensing mechanism 430 that is in communication with one or more of the second processor(s) 420. Motion sensing mechanism 430, which may be an accelerometer or the like is configured to detect specific motions applied to the user communication device 400.

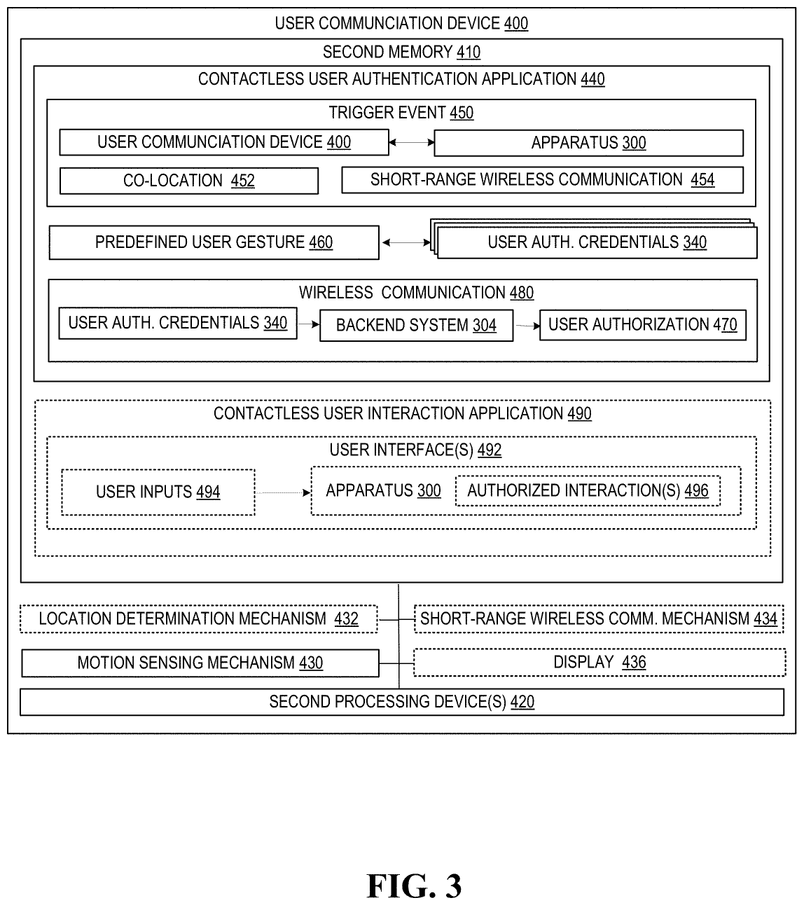

Additionally, second memory 410 of user communication device 400 stores contactless user authentication application 440 that is configured to provide the user touchless/contactless authentication at the apparatus 300. Specifically, contactless user authentication application 440 is configured to identify an occurrence of a triggering event 450 that is associated with the user communication device 400 and the apparatus 300. As will be explained in greater detail below in relation to FIG. 3, the triggering event 450 may be co-location of the user communication device 400 and the apparatus 300 (i.e., within a predefined geo-fence region that includes the user interface device of the apparatus 300), short-range wireless communication between the user communication device 400 and the apparatus 300 (e.g., “tapping” a Near Filed Communication (NFC)-equipped user communication device 40 to a corresponding reader on the apparatus 300 or the like). In response to identifying an occurrence of the triggering event 350, contactless user authentication application 440 is further configured to initiate monitoring of the user communication device for a predefined user gesture 460. The monitoring may be configured to continued for a specified period of time, such as 30 seconds, one minute or the like. The predefined user gesture 460 is predefined by the user and, in specific embodiments, is associated with specific user authentication credentials 340 (e.g., a specific password, specific personal identification number (PIN), a specific zip code or the like). The user gesture 460 may be any motion that is capable of being detected by the motion sensing mechanism 430 in the user communication device 400 and will vary depending on the type of user communication device 400.

In response to detecting the predefined user gesture 460, contactless user authentication application 440 is configured to wirelessly communicate the user authentication credentials 340 to the apparatus 300. In response to the apparatus 300 verifying the user authentication credentials 340, contactless user authentication application 440 is configured to provide the user authorization 380 for conducting subsequent interactions on the apparatus 300, on another device/apparatus and/or with one or more entities/individuals.

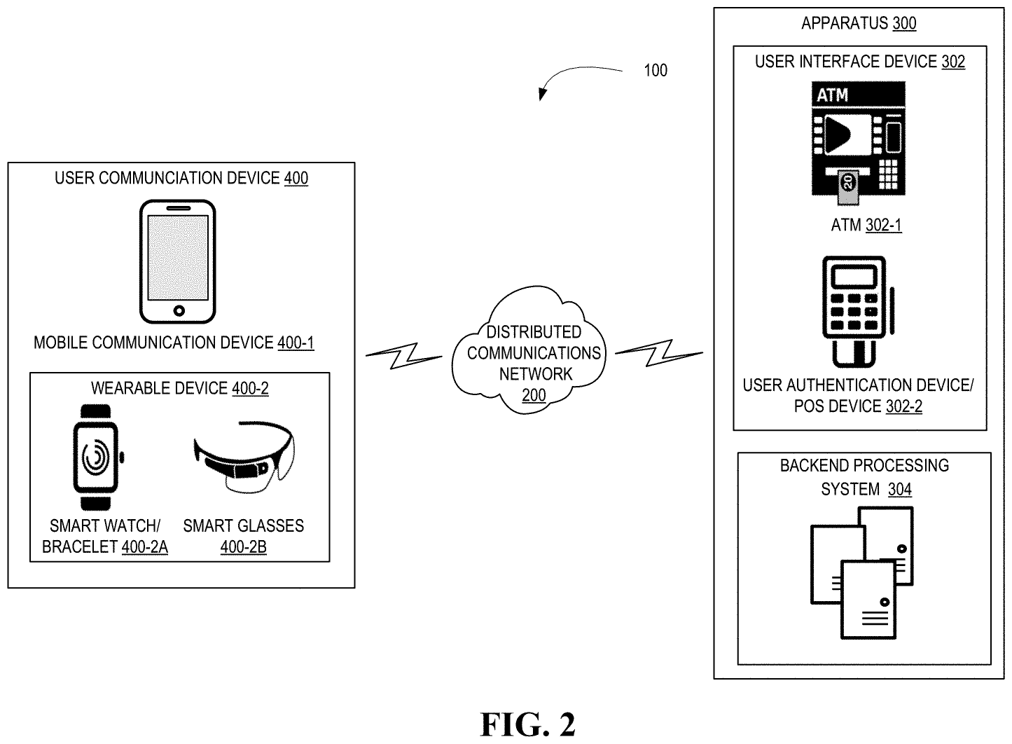

Referring to FIG. 2, a schematic/block diagram is present of a system 100 for touchless/contactless user authentication highlighting various different types of apparatus 300 and user communication devices 400 in accordance with embodiments of the present invention. Apparatus 300 may include any device that requires a user to provide user authorization credentials 340 to verify identity and/or authorize the user to perform subsequent interactions. In this regard, the user interface device 302 of apparatus 300 may comprise an Automated Teller Machine 302-1 or a Point-Of-Sale (POS) 302-2 or a stand-alone user authentication device 302-2 (i.e., similar in form to a POS device except the device merely performs user authentication as opposed to authorizing a transaction). Additionally, apparatus 300 may include backend processing system 304 which is in network communication with the user interface device 302 and user communication device 400 and is configured to verify the user authentication credentials 340 and communicate a verification response to the user interface device 302 of apparatus 300 and/or the user communication device 300.

User communication device 400 may comprise a mobile communication device 400-1, such as a smart phone or the like. Additionally, user communication device 400 may include a wearable device 400-2, such as, but not limited to, a smart watch/bracelet/ring 300-2A, smart glasses 400-2B or the like. In specific embodiments of the invention, in which the wearable device 400-2 is not configured for long-range wireless communication (e.g., cellular communication), the wearable device may be in short-range wireless communication (e.g., Bluetooth® or the like) with another user communication device (e.g., mobile communication device 400-1), which is configured for long-range wireless communication (e.g., cellular communication). In such embodiments of the invention, the wearable device 300-2 may detect the user gesture, while the other user communication device may wirelessly provide the user authentication credentials to the backend processing system 304 of apparatus 300. As such, it should be noted that user communication device 400 may comprise more than one unit/device.

Referring to FIG. 3, a block diagram is depicted of a user communication device 400 configured for touchless/contactless user authentication, in accordance with various alternate embodiments of the invention. User communication device 400, which may comprise one or more user devices (e.g., mobile communication device 400-1 and/or wearable devices 400-2), is configured to execute software programs, including instructions, algorithms, modules, routines, applications, tools and the like. User communication device 400 includes memory 410 and the like which may comprise volatile and non-volatile memory, such as read-only and/or random-access memory (RAM and ROM), EPROM, EEPROM, flash cards, or any memory common to computing platforms). Moreover, memory 410 and the like may comprise cloud storage, such as provided by a cloud storage service and/or a cloud connection service.

Further, user communication device 400 also includes at least one processing device 420, which may be an application-specific integrated circuit (“ASIC”), or other chipset, logic circuit, or other data processing device configured to execute the applications including the contactless user authentication application 440 and contactless user interaction application 490. Processing device(s) 420 or the like may execute one or more application programming interface (APIs) (not shown in FIG. 3) that interface with any resident programs, such as contactless user authentication application 440 and contactless user interaction application 490 or the like stored in the memory 410 of the user communication device 400 and any external programs. Processing device(s) 420 may include various processing subsystems (not shown in FIG. 3) embodied in hardware, firmware, software, and combinations thereof, that enable the functionality of user communication device 400 and the operability of user communication device 400 on distributed communications network 200, such as a cellular network, the Internet or the like. For example, processing subsystems allow for initiating and maintaining communications and exchanging data with other networked devices, such as apparatus 300. For the disclosed aspects, processing subsystems of user communication device 400 may include any processing subsystem used in conjunction with contactless user authentication application 440 and contactless user interaction application 490 and related engines, tools, routines, sub-routines, algorithms, sub-algorithms, sub-modules thereof.

User communication device 400 additionally includes a communications module (not shown in FIG. 3) embodied in hardware, firmware, software, and combinations thereof, that enables electronic communications between user communication device(s) 400 and other network devices, such as, but not limited to, apparatus 300. Thus, communication module may include the requisite hardware, firmware, software and/or combinations thereof for establishing and maintaining a network communication connection with one or more network devices.

Additionally, user communication device 400 includes motion sensing mechanism 430 that is in communication with one or more of the second processor(s) 420. Motion sensing mechanism 430, which may be an accelerometer or the like is configured to detect specific motions applied to the user communication device 400. In alternative embodiments of the invention, user communication device includes one or more of location determination mechanism 332 (e.g., Global Positioning Service (GPS) mechanism or the like) short-range wireless communication mechanism 334 (e.g., Near Field Communication (NFC) mechanism or the like) and/or display 336.

Memory 410 stores contactless user authentication application 440, which, as described in relation to FIG. 1, is configured to allow a user is input user authentication credentials 340 without having to touch or further contact the apparatus 300 or the user device 400. Contactless user authentication application 440 is configured to identify an occurrence of a triggering event 450 that is associated with the user communication device 400 and the apparatus 300. The triggering event 450 may be co-location 352 of the user communication device 400 and the apparatus 300. Co-location 353 may be defined by the user communication device 400 being located within a predefined geo-fence region that includes the user interface device of the apparatus 300. In such embodiments of the invention, the location of the user communication device 400 is determined by location determination mechanism 330. In other embodiments of the invention, the triggering event 450 may be the occurrence of short-range wireless communication 354 between the user communication device 400 and the apparatus 300. For example, the user communication device 400 may receive a short-range wireless communication from the apparatus 300 (e.g., the user communication device 400 equipped with NFC capabilities may “tap” the device to a corresponding reader located on the apparatus 300 or the like).

In response to identifying an occurrence of the triggering event 350, contactless user authentication application 440 is further configured to initiate monitoring of the user communication device for a predefined user gesture 460. The predefined user gesture 460 is predefined by the user and, in specific embodiments, is associated with specific user authentication credentials 340 (e.g., a specific password, specific personal identification number (PIN), a specific zip code or the like). In other embodiments of the invention, the user gesture 460 itself is the user authentication credential 340. The user gesture 460 may be any motion that is capable of being detected by the motion sensing mechanism 430 in the user communication device 400 and will vary depending on the type of user communication device 400. For example, a mobile communication device 400-1 held in the user's hand will detect any motion associated with the user's arm and/or hand; a smart watch/bracelet/ring 400-2A will detect any motion associated with the user's arm, wrist, hand and/or finger; and smart glasses 400-2B positioned on a user's head will detect any motion associated with the user's head.

In response to detecting the predefined user gesture 460, in specific embodiments of the invention, contactless user authentication application 440 is configured to determine which of a plurality of user authentication credentials 340 is associated with the predefined user gesture 460 prior to wirelessly communicating the user authentication credentials 340 to the apparatus 300. For example, if the user communication device is smart glasses an up-and-down movement of the head may be associated with a Personal Identification Number (PIN) used as user authentication credentials 340 at an ATM device or POS device while a side-to-side movement of the head may be associated with a zip code used as user authentication credentials 340 at a gas pump (i.e., specific type of POS device). In other embodiments of the invention, in which the user gesture 460 itself is the user authentication credential the need for the contactless user authentication application 440 to determine the corresponding user authentication credentials 340 is unnecessary.

In response to detecting the predefined user gesture 460, contactless user authentication application 440 is configured to wirelessly communicate the user authentication credentials 340 to the apparatus 300. In specific embodiments of the invention, the contactless user authentication application 440 communicates, via a cellular network, the user authentication credentials 340 to backend processing system 304, which is configured to verify the user authentication credentials and return, via a network connection, a verification response to the user interface 302 of the apparatus 300 and/or the user communication device. In other embodiments of the invention, the contactless user authentication application 440 communicates, via a short-range wireless communication link, the user authentication credentials to the user interface device 302 of the apparatus and, in turn, the user interface device 302 communicates, via network connection, the user authentication credentials 340 to the backend processing system 304 for verification. In response to the apparatus 300 verifying the user authentication credentials 340, contactless user authentication application 440 is configured to provide the user authorization 380 for conducting subsequent interactions on the apparatus 300, on another device/apparatus and/or with one or more entities/individuals.

In specific alternative embodiments of the invention, second memory 410 stores contactless user interaction application 490 that is executable by the one or more second processors 420 and is configured to, in response to the contactless user authentication application 440 verifying the user authentication credentials 340, present one or more user interfaces 492 on the display 436 of the user communication device 400 that are configured to receive user inputs 394 for conducting authorized interactions 496 on the apparatus 300 without having to physically contact the apparatus 300. For example, in those embodiments of the invention in which the apparatus 300 is an ATM, the user interfaces 492 provide the user the ability to conduct ATM interactions, such as requesting currency from an account, depositing currency to an account or the like without the user contacting the ATM (i.e., touching/contacting the ATM display or keypads). In specific embodiments of the invention, in which the user communication device 400 is a wearable device 400-2, the user interfaces 492 used to conducting interactions 496 may be displayed on the smart watch 400-2A face or on the interior display/screen of smart glasses 400-2B.

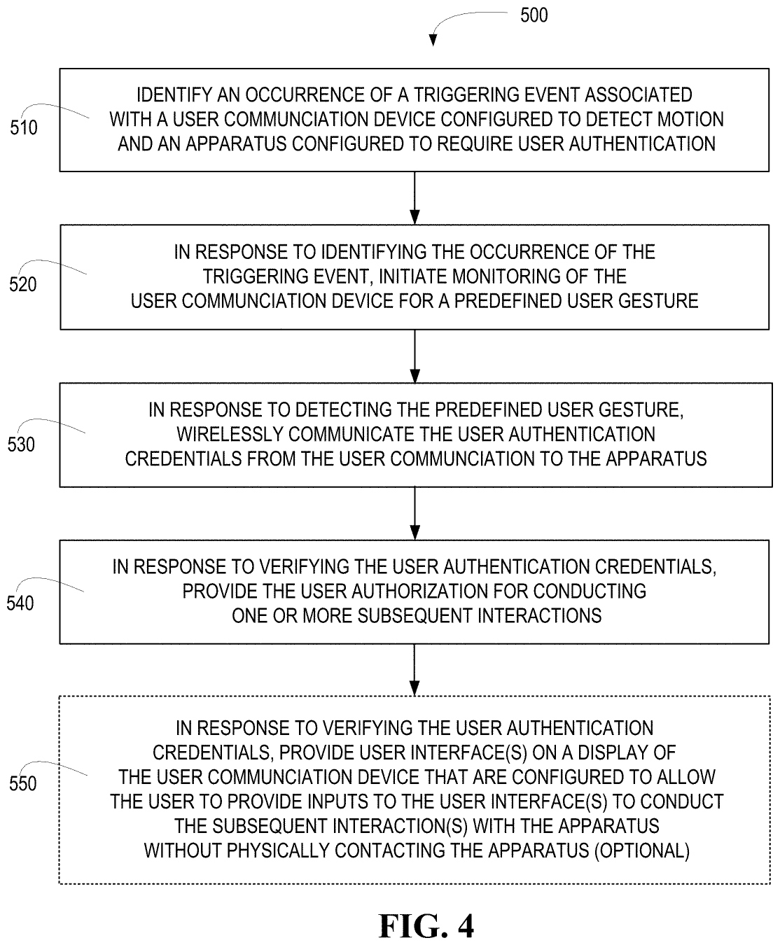

Referring to FIG. 4 a flow diagram is presented of a methodology 500 for touchless/contactless user authentication, in accordance with embodiments of the present invention. At Event 510, the occurrence of a triggering event is identified. The triggering event is associated with a user communication device and apparatus. In specific embodiments of the method, the triggering event is co-location between the user communication device and the apparatus. In other embodiments of the method, the triggering event is short-range wireless communication between the user communication device and the apparatus.

The user communication device is configured to detect motion. In specific embodiments of the method, the user communication device is a mobile communication device and/or a wearable device, such as a smart watch/bracelet/ring, smart glasses or the like. The user communication device may additionally be configured to identify physical location, and/or communicate via short-range wireless communication (e.g., NFC or the like).

The apparatus may be any apparatus that requires a user to authenticate (i.e., input a password, PIN, zip code or the like to conduct further interactions/transactions). For example, the apparatus may include a user interface device, such as, but not limited to, an ATM, a POS device, a stand-alone user authentication device or the like. Additionally, the apparatus may include backend processing devices/systems (e.g., servers or the like) that are in network communication with the user interface device and wireless network communication with the user communication device.

In response to identifying the occurrence of triggering event, at Event 520, the user communication device begins monitoring for a predefined user gesture. In this regard, the motion sensing mechanisms within the user communication device are activated to begin monitoring for a predefined motion (i.e., predefined user gesture). The predefined motion may be a motion to the arm, hand, wrist, finger(s), head or the like chosen by the user and associated with a specific user authentication credential. In this regard, each specific user authentication credential that the user implements for authentication purposes (i.e., each password, PIN or the like) may be assigned to a different user gesture. Typically, the monitoring will last for a predetermined time period that allows for the user to make the gesture such as a few seconds or up to one minute.

In response to the user communication device detecting the predefined user gesture, at Event 530, the user authentication credentials are communicated to the apparatus. In specific embodiments of the method, the communication of the user authentication credentials is preceded by determining which one of a plurality user authentication credentials is associated with the user gesture. In other embodiments of the method, the user gesture itself is the user authentication credentials. In specific embodiments of the method, wirelessly communicating the user authentication credentials to the apparatus includes communicating, via a cellular network, the user authentication credentials to backend processing systems/device which are configured to verify that the user authentication credentials are associated with the user. In such embodiments of the method, in response to verifying the user authentication credentials, the backend processing systems/device communicate a verification acceptance/authorization to the user interface device of the apparatus and/or the user communication device.

In response to verifying the user authentication credentials, at Event 540, the user is provided authorization for conducting one or more interactions/transaction. The interactions/transactions may be via the apparatus (e.g., ATM, POS or the like) or with an individual interfacing with the user (e.g., bank teller or the like).

Additionally, in response to verifying the user authentication credentials, at optional Event 550, user interfaces are provided on the user communication device (i.e., a contactless user interaction application is launched or the like) on a display of the user communication device that are configured to allow the user to provide inputs to the user interfaces to conduct interactions with the apparatus without having to physically contact the apparatus. For example, in those embodiments in which the apparatus is an ATM, once the user has been authorized (i.e., the user authentication credentials have been verified), the bank application or the like may be launched and user interfaces are displayed within the bank application similar to or the same as those that would be displayed on the ATM. The user interfaces may be configured to allow the user to withdraw currency, deposit currency or conduct without having to come in physical contact with the ATM.

As evident from the preceding description, the systems, methods and the like described herein represents an improvement in human well-fare, specifically, embodiments of the present invention provide for contactless user authentication at apparatus requiring such. In this regard, the user authentication credentials are input or otherwise communicated to the apparatus absent the need to physically contact the input mechanisms of the apparatus or the display of the user communication device. The invention relies on the user communication device to detect preconfigured user gestures, which are either associated with specific user authentication credentials or serve as the user authentication credential. Once the gesture is detected, the user authentication credentials are wirelessly communicated from the user communication to backend processing systems for verification purposes. Monitoring for the preconfigured user gesture is initiated by a triggering event, which may include co-location of the user communication device and the apparatus or short-range wireless communication between the user communication device and the apparatus.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for contactless user authentication, the system comprising:
an apparatus including a first memory and at least one processor in communication with the memory, wherein the apparatus is configured to require a user to provide user authentication credentials to authorize the user for conducting one or more subsequent interactions;
a user communication device including a second memory, at least one second processor in communication with the second memory and a motion sensing device in communication with the at least one second processor; and
a contactless authentication application stored in the second memory, executable by the second processor and configured to:
identify a triggering event associated with the user communication device and the apparatus,
in response to identifying an occurrence of the triggering event, initiate monitoring of the user communication device for a predefined user gesture,
in response to the motion sensing device detecting an occurrence of the predefined user gesture, wirelessly communicate the user authentication credentials to the apparatus, and
in response to verifying the user authentication credentials, provide the user authorization for conducting the one or more subsequent interactions.

2. The system of claim 1, wherein the user communication device further comprises a location determining mechanism in communication the at least one second processor, and
wherein the triggering event is determination of co-location between the user communication device and the apparatus.

3. The system of claim 1, wherein the user communication device further comprises a short-range wireless communication mechanism in communication with the at least one second processor, and
wherein the triggering event is detection of short-range wireless communication between the user communication device and the apparatus.

4. The system of claim 1, wherein the user communication device is a mobile communication device or a wearable device including a display in communication with the at least one second processor.

5. The system of claim 4, wherein the contactless authentication application is further configured to, in response to verifying the user authentication credentials, provide one or more user interfaces on the display that are configured to allow the user to provide inputs to the user interfaces to conduct one or more subsequent interactions with the apparatus without physically contacting the apparatus.

6. The system of claim 1, wherein the apparatus is selected from the group consisting of (i) an automated teller machine, (ii) a point of transaction device and (iii) an identification verification device.

7. The system of claim 1, wherein the contactless authentication application is further configured to wirelessly communicate the user authentication credentials to the apparatus by communicating, via a wireless network connection, the user authentication credentials to a backend system configured to verify the user authentication credentials and wherein the backend system is configured to, in response to verifying the user authentication credentials, communicate, via a network connection, the user authorization to the apparatus.

9. The system of claim 1, wherein the contactless authentication application is further configured to, in response to identifying the occurrence of the triggering event, determine the user authentication credentials required by the apparatus.

10. The system of claim 1, wherein the contactless authentication application is further configured to wirelessly communicate the user authentication credentials to the apparatus, wherein the user authentication credential is the predetermined gesture.

11. A computer-implemented method for contactless user authentication, the method executed by at least one computing device processor and comprising:
identifying an occurrence of a triggering event associated with a user communication device configured to detect motion and an apparatus configured to require a user to provide user authentication;
in response to identifying the occurrence of the triggering event, initiating monitoring of the user communication device for a predefined user gesture;
in response to the detecting the predefined user gesture, wirelessly communicating the user authentication credentials to the apparatus; and
in response to verifying the user authentication credentials, providing the user authorization for conducting one or more subsequent interactions.

12. The computer-implemented method of claim 11, wherein identifying the occurrence of a triggering event further comprises determining co-location between the user communication device and the apparatus.

13. The computer-implemented method of claim 11, wherein identifying the occurrence of a triggering event further comprises detecting short-range wireless communication between the user communication device and the apparatus.

14. The computer-implemented method of claim 11, further comprising:
in response to verifying the user authentication credentials, providing one or more user interfaces on a display of the user communication device that are configured to allow the user to provide inputs to the user interfaces to conduct one or more subsequent interactions with the apparatus without physically contacting the apparatus.

15. The computer-implemented method of claim 11, wherein wirelessly communicating the user authentication credentials to the apparatus further comprises:
communicating, via a wireless network connection, the user authentication credentials to a backend system configured to verify the user authentication credentials; and
in response to the backend system verifying the user authentication credentials, communicating, via a network connection, the user authorization to the apparatus.

16. The computer-implemented method of claim 11, further comprising:
in response to identifying the occurrence of the triggering event, determining the user authentication credentials required by the apparatus.

17. A computer program product including a non-transitory computer-readable medium that comprises:
a first set of codes for causing a computer to identify an occurrence of a triggering event associated with a user communication device configured to detect motion and an apparatus configured to require a user to provide user authentication;
a second set of codes for causing a computer to, in response to identifying the occurrence of the triggering event, initiate monitoring of the user communication device for a predefined user gesture;
a third set of codes for causing a computer to, in response to the detecting the predefined user gesture, wirelessly communicate the user authentication credentials to the apparatus; and
a fourth set of codes for causing a computer to, in response to verifying the user authentication credentials, provide the user authorization for conducting one or more subsequent interactions.

18. The computer program product of claim 17, wherein the first set of codes is further configured to identify the occurrence of a triggering event by determining co-location between the user communication device and the apparatus.

19. The computer program product of claim 17, wherein the first set of codes is further configured to identify the occurrence of a triggering event by detecting short-range wireless communication between the user communication device and the apparatus.

20. The computer program product of claim 17, further comprising:
A fifth set of codes for causing a computer to, in response to verifying the user authentication credentials, providing one or more user interfaces on a display of the user communication device that are configured to allow the user to provide inputs to the user interfaces to conduct one or more subsequent interactions with the apparatus without physically contacting the apparatus.
